(19) United States
(12) Patent Application Publication
(10) Pub. No.: US 2010/0030532 A1
(43) Pub. Date: Feb. 4, 2010

(54) System and methods for digital human model prediction and simulation

(76) Inventors: Jasbir Arora, Iowa City, IA (US); Karim Abdel-Malek, Iowa City, IA (US); Yujiang Xiang, Iowa City, IA (US); Joo H. Kim, Brooklyn, NY (US); Steve Beck, Iowa City, IA (US); R. Timothy Marler, Iowa City, IA (US); Rajan Bhatt, Coralville, IA (US)

Correspondence Address: Charles C. Valauskas;Valauskas & Pine LLC, Suite 620, 150 South Wacker Drive, Chicago, IL, 60606, US

(21) Appl. No.: 12/456,239

(22) Filed: Jun. 12, 2009

Related U.S. Application Data
(60) Provisional application No. 61/131,794, filed on Jun. 12, 2008.

(51) Int. Cl. G06G 7/60; G06F 17/10; G06T 15/70

(52) U.S. Cl. 703/2; 345/474; 703/11

(57) ABSTRACT

Optimization algorithms and techniques to predict and simulate motion and various performance of a digital human model. The human body is modeled as a kinematics system represented by a series of segments connected by joints that represent musculoskeletal joints such as the wrist, elbow, shoulder, clavicle and pelvis. Optimization tools are used to determine the rotation at each degree of freedom of each joint that minimizes a performance measure.

This invention was made with government support under DAAE07-03-D-L003 awarded by the U.S. Army TACOM and W911QY-06-C-0034 awarded by the U.S. Army Soldier Center. The government has certain rights in the invention.

### FIELD OF THE INVENTION

The present invention relates generally to animation and more particularly to a dynamics algorithm for predicting and simulating motion using a digital model.

### BACKGROUND OF THE INVENTION

Animation generally refers to the combination of graphics with the dimension of time. To produce quality computer animation, it is necessary to study the motions of the object being represented and form an animation program on the basis of the analysis. The analysis requires observation and only provides a finite set of movement data, which can therefore only predict a finite number of scenarios. Observations are subjective and, therefore, the computer animation typically incorporates some deviation from reality.

The present application is discussed herein with respect to humans for exemplary purposes only. It is contemplated that the present invention is applicable to animation applications of any object that moves such as animals or vehicles.

Animation applies kinematics to the motions, which describes the motions only in terms of positions, rotation, scaling, velocities and accelerations, neglecting forces and torques. Kinematics analysis only generates a line picture representing parts constituting a human body, and a three-dimensional model of the human body cannot be displayed realistically.

Inverse kinematics (“IK”) for computer animation has also been used, which processes a desired position in three-dimensional space and is used to calculate angles, for example body joint angles. The IK methodology is based upon complex matrix manipulations that require significant amounts of processing to determine the joint angles associated with limb movements. The amount of processing increases as a cubic of the number of joints involved, translating into lengthy processing times when numerous joints are involved. A human being has many degrees of freedom (“DOF”), which makes it practically impossible to use matrix-based inverse kinematic methods to interactively animate any realistic human character in real time. And, matrix-based IK methods may not even work on certain joint configurations known as singular configurations. Furthermore, the prior art notes that with multiple limb and joint movements, the end result of the computations will not appear natural.

Additionally, prior IK methods must converge to a solution before the results of the computation can be used for the animation. Partially computed results cause unstable, jerky and oscillatory motion of the limbs, with large positioning errors.

Dynamics provides another method of motion analysis. Dynamics analyzes motions of objects based on the relation between movements and forces, as compared to kinematics, which provides motion analysis in terms of positions, velocities and accelerations. Dynamics allows more complex behavioral or animated results. But, computer analysis of motions utilizing dynamics requires data on parameters such as the moments of inertia, the centers of gravity, joint friction and muscle/ligament elasticity of the moving part being represented by the animation. Dynamics motion analysis also requires complex dynamics equations of multiple and simultaneous differential equations. Solving a problem based on dynamics involves differential equations that describe the relationship between mass and force and torque. There are a number of equations used for describing dynamics, but the most familiar formulation is Lagrange's equation. The dynamic motion analysis directly integrates the equations of motion, which is time consuming. Thus, the dynamic motion approach can only be applied to small scale models.

Besides resulting in poor quality and non-original movement sequences, the existing technology is time consuming and laborious. In order to reduce the workload, the number of moving parts is usually limited. However, life-like movement is usually the result of multiple joint and limb movement and using a lesser degree of movement results in an unnatural animation. Existing technology is limited by the accuracy of experimental data and fails to provide an adequate dynamics model that can generate natural and realistic human motion.

Digital human modeling and simulation is a form of animation that has been assisting industrial designs and planning for more than a decade. In scenarios where it is unsafe or expensive to have real human testing, digital human modeling and simulation is desirable. While it is relatively simple to create jagged and unrealistic movements, generating interactive sequences of animation that follow natural human/animal motion is difficult to create.

What is needed is a system and methods for prediction and simulation of human modeling that does not rely on integration of equations of motion and is general in that it can be applied to any size human model as well as to any motion or task. The predictive and simulative approach of the present invention satisfies this demand.

### SUMMARY OF THE INVENTION

The present invention is an optimization-based algorithm that efficiently predicts and simulates various human tasks in a natural way by providing an infinite set of movement to any size human model. For purposes of this application, the term “motion” or “task” are used interchangeable herein and include any action or part of an action which accomplishes a job, problem or assignment, for example, walking (forward or backward), running, throwing, climbing stairs, lifting and carrying objects, and many other motions or tasks. The algorithm according to the present invention predicts physics-based motion and naturalistic motion of various segments of the body. Prediction of physics-based motion further allows for monitoring, calculating or analyzing human performance measures.

The ability to predict and simulate various human tasks is advantageous in numerous applications. Applications include, but are not limited to, safety, ergonomics, military, environment, manufacturing, performance such as athletic performance, aerospace, health, science, assembly, automobile, serviceability, training, packaging, entertainment such as theatre and movies, gaming, and validation. For example, the present invention may be used to predict and simulate human tasks related to the military in real-time, such as when the task is designed. As another example, the present invention may be used to predict and simulate manufacturing or assembly line tasks to address safety and ergonomics issues. The present invention may also be used to predict and simulate training activities such as instructing trainees on how to accomplish a particular job function. Another example of the present invention is to predict and simulate sports activities of athletes in order to evaluate and design sports equipment. The present invention may also predict and simulate injuries, prevention of injuries, and rehabilitation from injuries.

The present invention is applicable to any “predictive dynamics” For purposes of this application, the term predictive dynamics is a class of physics-based problems that are modeled using differential equations of motion and that would otherwise require the solution of such problems using time-step integration. However, in this case, predictive dynamics is a broadly applicable formulation for addressing such problems using optimization techniques without having to integrate the equations of motion. Indeed, the formulation does not have a unique solution, and constraints play an important role in the solution process.

The present invention capitalizes on an optimization-based approach to motion prediction, wherein motion is governed by human performance measures, such as speed and energy, which act as objective functions in an optimization formulation. In addition, constraints on joint torques and angles are imposed quite easily. Predicting motion in this way allows one to use digital human models to study how and why humans move the way they do, given a specific scenario. It also enables digital human models to react to infinitely many scenarios with substantial autonomy. In addition, by using optimization, it is possible to predict dynamic motion without having to integrate equations of motion, which can be a cumbersome process. Rather than solving the equations of motion, the predictive dynamics generalized method uses the mature field of optimization to solve for a continuous time-dependent curve characterizing joint variables (also called joint profiles) for every degree of freedom. The present invention predicts human motion, in part, is by taking into consideration human performance measures as objective functions to be minimized or maximized and many realistic constraints on the motion and various forces.

The present invention uses optimization algorithms and techniques to predict motion and various performance of a digital human model. The human body is modeled as a kinematics system represented by a series of segments connected by joints that represent musculoskeletal joints such as the wrist, elbow, shoulder, clavicle and pelvis. Optimization tools are used to determine the rotation at each degree of freedom of each joint that minimizes a performance measure, for example, discomfort.

The present invention generates realistic digital human models including anatomy, biomechanics, physiology, and intelligence in real-time. According to the present invention, the digital human is modeled as a mechanical system that includes link lengths, mass moments of inertia, joint torques, and external forces. These digital human models—through the use of algorithms—predict every possible variable in a gait cycle while taking into consideration variables such as loading, joint ranges of motion, moments of inertia, anthropometry, body types, terrain, to name a few. The entire model has 55 DOF—6 for global translation and rotation and 49 for the body. A DOF in this case characterizes a kinematics jointed pair in the kinematics sense, where various segments of the body are assumed to be connected by revolute joints. The B-spline interpolation is used for time discretization, and the Denavit-Hartenberg (“DH”) method is used for kinematics analysis. The recursive Lagrangian formulation is used for the equations of motion since it is considered to be quite efficient. The equations of motion are verified by the forward dynamics process using a commercial general-purpose multi-body dynamics software code.

A method to predict and simulate a human task using an optimization-based approach is presented. The digital human is considered as a mechanical system that includes link lengths, mass moments of inertia, joint torques, and external forces. Problems are formulated as optimization problems to determine the joint angle profiles. The kinematics analysis of the model is carried out using the Denavit-Hartenberg method. The B-spline approximation is used for discretization of the joint angle profiles, and the recursive formulation is used for the dynamic equilibrium analysis. The equations of motion thus obtained are treated as equality constraints in the optimization process. With this formulation, a method for the integration of constrained equations of motion is not required. This is a unique feature of the present invention and has advantages for the numerical solution process. The formulation also offers considerable flexibility for simulating different task conditions quite routinely. The zero moment point (“ZMP”) constraint is imposed in the optimization problem to generate several realistic simulations of a human performing a task.

In one embodiment, the present invention is a method for simulating human motion by defining a skeletal model of the human body including mechanical properties of its segments. A forward recursive approach is used such as to describe a large number of degrees of freedom for the kinematics of the human skeletal model with the Denavit-Hartenberg method where the joint angle profiles are the primary unknown variables. Joint angle profiles are joint angles as a function of time. Limits may be varied such as limits for body size, shape, gender, strength, and fatigue. Additionally the load conditions such as loads, terrain topology and obstacles on the human body can be altered, which may further be specified by load, position and orientation. A backwards recursive dynamic formulation is utilized to produce sensitivities of kinematics and dynamics equations with respect to all the state variables. Equations of motion are developed for the human skeletal model based on the Lagrangian approach and such equations can be solved without numerical integration. A human performance objective function for a dynamic task is specified wherein the dynamic task is one selected from the group of discomfort, energy consumption, vision, dynamic effort, or any other function of kinematic and kinetic variables such as human performance measures to yield natural human motion for a given task. A backwards recursive dynamic formulation in combination with two or more human performance measures yields varying behavior for the predicted natural human motion. Utilizing varying cost functions and varying constraints enables the simulation of any human task while considering physics and naturalistic human behavior. Human endurance limits given a trade-off analysis are analyzed. Various constraints for the dynamic task to be simulated are identified and the bound on joint angles and strength limits are indicated. The optimization problem is solved using an optimization algorithm to predict dynamic motion. A solution is obtained with optimization and without resolving equations of motion. An animated human model is generated.

The method is performed on a computer system. A general computer system according to the present invention includes a central processing unit (“CPU”), a read-only memory (“ROM”), a random access memory (“RAM”), and a memory hard disk, all interconnected by a system bus. The memory hard disk serves as a storage device and may further include a database.

An object of the present invention is to provide a method that includes the human aspects of naturalistic motion and predictive behavior.

An object of the present invention is to provide implementation in general purpose software to simulate various human tasks in a very efficient manner.

Yet another object of the present invention is to provide a predictive dynamics algorithm that can simulate motion of humans in a very realistic and efficient way.

Another object of the present invention is to save time and resources. Minimal physical prototyping is needed since the task can be predicted and simulated in a digital environment.

Another object of the present invention is to provide very large and accurate digital human models that simulate various human activities, such as balance and gait prediction, task segmentation, single chain motion, prediction, swinging motion, climbing a ladder, walking, running, lifting a box, delivering a box, stair climbing, throwing objects, etc.

Another object of the present invention is to treats equations of motion as constraints without ever integrating them in time.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

FIG. 1 illustrates a human running cycle;

FIG. 2 is a flow chart of an optimization-based predictive dynamics process;

FIG. 3 illustrates articulated chains;

FIG. 4 illustrates Denavit and Hartenberg parameters;

FIG. 5 illustrates a mechanical structure of a digital human model;

FIG. 6 illustrates a single pendulum model;

FIG. 7 is a graph of results illustrating a comparison of joint angle and joint angle velocity;

FIG. 8 illustrates the zero moment point;

FIG. 9 is a flow chart of inputs and outputs of an optimization process;

FIG. 10 illustrates a mechanical structure of a digital human model;

FIG. 11 is a graphical illustration of a digital human model;

FIG. 12 is a graphical illustration of a digital human model;

FIG. 13 is a graphical illustration of a digital human model;

FIG. 14 is a graph of results illustrating a comparison of normal running and running with a backpack;

FIG. 15 is a graph of results illustrating a right knee joint angle profile;

FIG. 16 is a graph of results illustrating a ground reaction force on a foot;

FIG. 17 illustrates a mechanical structure of a digital human model;

FIG. 18 illustrates a top view of four basic supporting modes;

FIG. 19 illustrates results of a normal step with initial and final postures

FIG. 20 illustrates results of applying ground reaction forces on zero moment point;

FIG. 21 is a flow chart of a two-step algorithm;

FIG. 22 illustrates results of foot ground penetration;

FIG. 23 illustrates the results of an optimized cyclic walking motion;

FIG. 24 is a graph of results illustrating joint torque profiles;

FIG. 25 is a graphical illustration of a digital human model;

FIG. 26 is a graph of results of vertical ground reaction forces;

FIG. 27 is a graph of results of knee torques;

FIG. 28 is a graph of results of joint angle profile verification; and

FIG. 29 is an exemplary computer system, or network architecture, that may be used to implement the methods according to the present invention.

### DETAILED DESCRIPTION OF EMBODIMENTS OF THE INVENTION

The detailed description of the preferred embodiments below is discussed with respect to the predictive dynamics of running and walking for illustrative purposes only. The present invention is applicable to any contemplated task.

In one embodiment discussed herein, the present invention is formulated as an optimization-based predictive dynamics problem for running. In another embodiment discussed herein, the present invention is formulated as an optimization-based predictive dynamics problem for walking. First, the problem of running is discussed.

In the problem of running, the objective is to predict (or calculate) joint angles and torques at the joints over time, also called joint and torque profiles, respectively. For the problem of running, a minimal set of constraints is imposed in the formulation of the problem to simulate natural running of the digital human. The human running problem is distinguished from the walking problem in that there is a flight phase during each step of running. In the present formulation, running steps are assumed to be periodic and symmetric for the right and left steps. Both the support phase and the flight phase are modeled.

The running problem is formulated as a nonlinear optimization problem. A unique feature of the formulation is that the equations of motion are not integrated explicitly, which provides for a generalized method to solve dynamic indeterminate problems that would otherwise require computationally intensive integration methods. They are imposed as equality constraints in the optimization process. An algorithm based on the sequential quadratic programming approach is used to solve the nonlinear optimization problem. The control points for the joint angle profiles are treated as design variables; when calculated, they provide for the complete motion. For the performance measure in the optimization problem, the mechanical energy that is represented as the integral of the sum of the squares of all the joint torques is minimized. The dynamic stability is achieved by satisfying the Zero Moment Point (“ZMP”) constraint in the support phase. The Zero Yawing Moment (“ZYM”) constraint is imposed so that the upper-body motion is compensated by the lower-body motion. The solution is simulated in a human modeling and simulation environment. The simulations show a very natural running motion of the digital human. The joint torque and angle profiles and ground reaction forces are recovered from the simulation. A couple of simulations of running at different speeds and carrying loads on the back are generated quite routinely and efficiently.

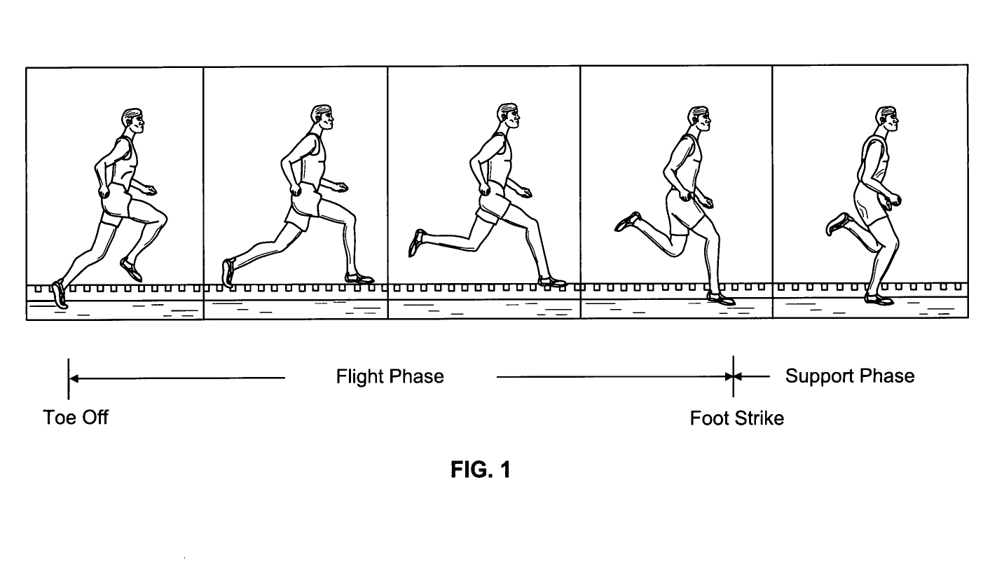

Considering the human running gait cycle, the running style depends on the speed of running. For example, at slower running speeds, the heel touches the ground first. In fast running or sprinting, the fore-foot touches the ground first. Moreover, the upper body motion is different for slower and faster running such as sprinting. The faster the runner's speed, the more arm swinging motion is generated to minimize energy consumption. Running is differentiated from walking not by the speed but by the existence of a flight phase. During a walk, whether slow or fast, there exists a double support phase (where both feet are on the ground). The period from the initial contact of one foot to the following contact of the same foot is called the gait cycle. According to the present invention, the gait cycle of running is composed of two phases: the support phase and the flight phase. The flight phase starts with a toe off and ends with the strike of the other foot. The support phase starts with a foot strike and ends with same foot's toe off as shown in FIG. 1. In the area of biomechanics, the distance from one foot's strike to the other foot's strike is called a step. Also, the distance from one foot's strike to the same foot's subsequent strike is called a stride.

Using optimization techniques, the digital human's motion can be predicted as along with the relative joint torques and external forces. The basic idea is to determine joint angle profiles and torque profiles to optimize some objective function, for example, metabolic energy consumption and joint torques.

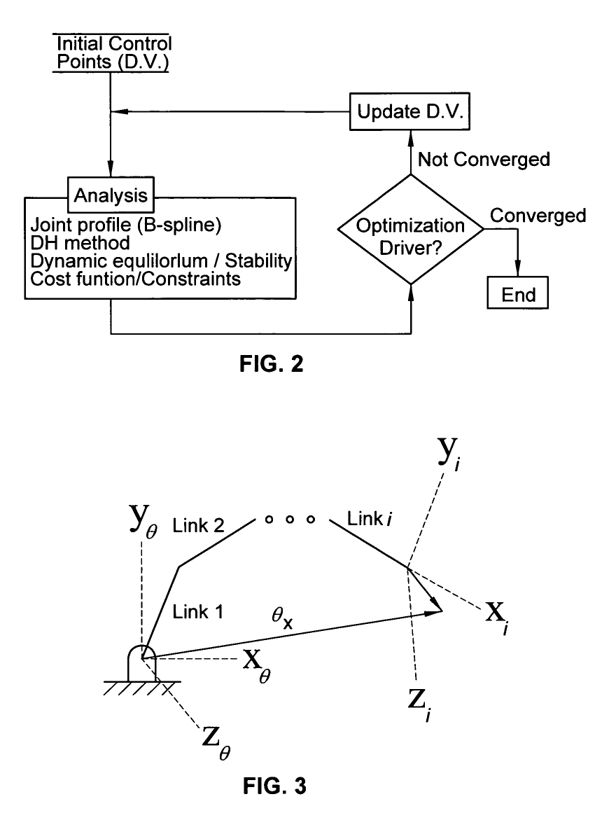

FIG. 2 illustrates the entire optimization process. First, the initial control point values for the joint angle profiles are given. Then, the control points are passed on to the analysis module. The analysis module uses the B-spline module, DH module, equations of motion module, and cost function/constraints module. Through this module, cost function and constraints values are obtained. Using the cost function and constraint function values and their gradients, the optimization module checks whether or not the current values are optimum. If the stopping criteria are not satisfied, the B-spline control points are updated by the optimization module. The entire process is repeated again until an optimum solution is obtained. The B-spline method, DH method, and equations of motion are discussed in further detail below.

The joint angles are functions of time. These functions can be represented as a linear combination of cubic B-spline basis functions. Given a knot vector t={t₀, t₁, t₂, . . . , tₘ} and control points \hat{q}₀ \hat{q}₁, . . . , \hat{q}ₙ, the approximation is defined as

$$q ( t ) = {\sum }_{i = 0}^{n} {N}_{i , p} ( t ) {\hat{q}}_{i} \qquad ( 1 )$$

where N_{i,p} is the i^{th} basis function of degree p. The basis function N_{i,p} (t) is given in the recursive form as

$$\begin{matrix}{N}_{i , p} ( t , t ) = ( \frac{t - {t}_{i}}{{t}_{i + p} - {t}_{i}} ) {N}_{i , p - 1} ( t , t ) + ( \frac{{t}_{i + p + 1} - t}{{t}_{i + p + 1} - {t}_{i + 1}} ) {N}_{i + 1 , p - 1} ( t , t ) \\ and & ( 2 ) \\ {N}_{i , 0} ( t , t ) = \{ \begin{matrix}1 & ( {t}_{i} \leq t < {t}_{i + 1} ) \\ 0 & otherwise\end{matrix} & ( 3 )\end{matrix}$$

The relation between the number of knots m+1 and the number of control points n+1 is

m=n+p+1 (4)

The Cubic B-spline curves which have basis functions of degree 3 in the local interval tᵢ≦t<ᵢ₊₁ is

$$\begin{matrix} q ( t ) = {\sum }_{j = 0}^{3} {N}_{i - j , 3} ( t ) {\hat{q}}_{i - j} \\ i \geq 3 \\ and & ( 5 ) \\ {N}_{i - 3 , 3} = \frac{{( {t}_{i + 1} - t )}^{3}}{( {t}_{i + 1} - {t}_{i} ) ( {t}_{i + 1} - {t}_{i - 1} ) ( {t}_{i + 1} - {t}_{i - 2} )} & ( 6 a ) \\ {N}_{i - 2 , 3} = \frac{( t - {t}_{i - 2} ) {( {t}_{i + 1} - t )}^{2}}{( {t}_{i + 1} - {t}_{i - 2} ) ( {t}_{i + 1} - {t}_{i - 1} ) ( {t}_{i + 2} - {t}_{i} )} + \frac{( t - {t}_{i - 1} ) ( {t}_{i + 1} - t ) ( {t}_{i + 2} - t )}{( {t}_{i + 1} - {t}_{i - 1} ) ( {t}_{i + 1} - {t}_{i} ) ( {t}_{i + 2} - {t}_{i - 1} )} + \frac{( t - {t}_{i} ) {( {t}_{i + 2} - t )}^{2}}{( {t}_{i + 1} - {t}_{i} ) ( {t}_{i + 2} - {t}_{i - 1} ) ( {t}_{i + 2} - {t}_{i} )} & ( 6 b ) \\ {N}_{i - 1 , 3} = \frac{{( t - {t}_{i - 1} )}^{2} ( {t}_{i + 1} - t )}{( {t}_{i + 1} - {t}_{i - 1} ) ( {t}_{i + 2} - {t}_{i} ) ( {t}_{i + 2} - {t}_{i - 1} )} + \frac{( t - {t}_{i - 1} ) ( t - {t}_{i} ) ( {t}_{i + 2} - t )}{( {t}_{i + 1} - {t}_{i} ) ( {t}_{i + 2} - {t}_{i - 1} ) ( {t}_{i + 2} - {t}_{i} )} + \frac{{( t - {t}_{i} )}^{2} ( {t}_{i + 3} - t )}{( {t}_{i + 1} - {t}_{i} ) ( {t}_{i + 2} - {t}_{i} ) ( {t}_{i + 3} - {t}_{i} )} & ( 6 c ) \\ {N}_{i , 3} = \frac{{( t - {t}_{i} )}^{3}}{( {t}_{i + 1} - {t}_{i} ) ( {t}_{i + 2} - {t}_{i} ) ( {t}_{i + 3} - {t}_{i} )} & ( 6 d )\end{matrix}$$

To generate clamped B-spline curves which touch the first and last control points, multiple knots of multiplicity 4 are used at the first and the last knots.

A matrix transformation method to describe the translational and rotational relationship systematically between adjacent links in articulated chain is the DH method. The transformation matrix is a 4×4 homogeneous matrix. This method represents each link coordinate system in terms of the previous link coordinate system. Then any local coordinate system (including the end-effector of the manipulator or serial chain) can be expressed in an original reference by the DH method. Basically, the method represents a vector in one coordinate frame in terms of the other coordinate frame. This method has its base in the field of robotics but can be used for modeling human kinematics as well.

FIG. 3 illustrates articulated chains. Any point of interest in the i^{th} frame ⁱx can be transferred to the global reference frame ⁰x:

⁰x=⁰Tᵢⁱx (7)

where ⁱx is a 4×1 vector in terms of the i^{th} reference frame and ⁰Tᵢ is a 4×4 homogeneous transformation matrix from the i^{th} reference frame to the global reference frame.

Here the transformation of a vector to the global reference frame is simply multiplication of transformation matrices, which is given as:

$${}_{}^{0}{T}{}_{i}^{} = {}_{}^{0}{T}{}_{1}^{} {}_{}^{1}{T}{}_{2}^{} … {}_{}^{i - 1}{T}{}_{i}^{} = {\prod }_{n = 1}^{i} {}_{}^{n - 1}{T}{}_{n}^{} \qquad ( 8 )$$

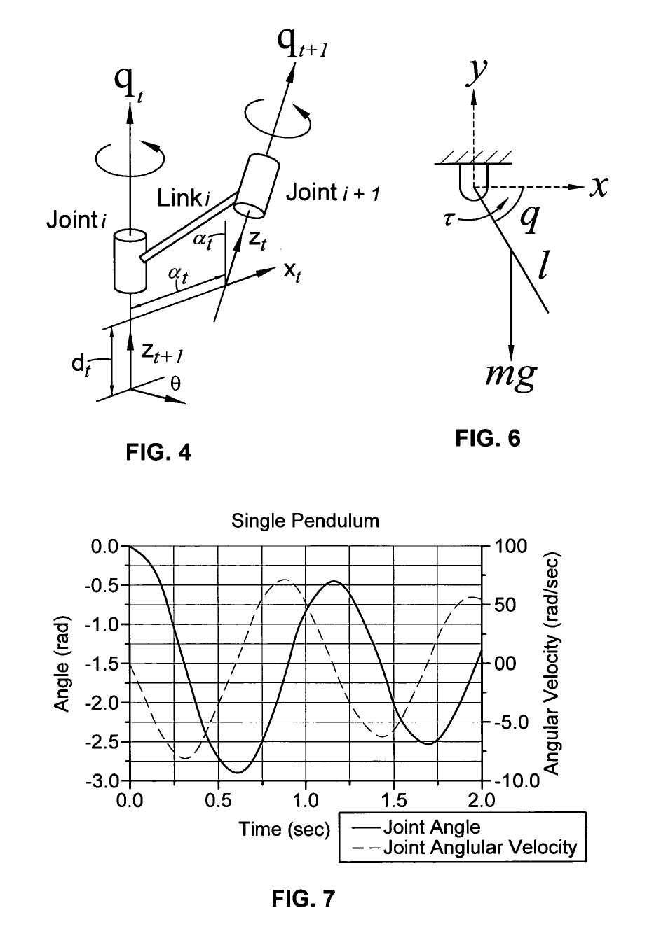

The transformation matrix of this vector is a 4×4 matrix that includes four DH parameters, which are shown in FIG. 4. The DH parameters in FIG. 4 are defined as follows: θᵢ is the joint angle between the xᵢ₋₁ axis and the xⁱ axis about the zᵢ₋₁ axis according to the right-hand rule; dᵢ is the distance between the origin of the i−1^{th} coordinate frame and the intersection of the zᵢ₋₁ axis with the xⁱ axis along the zᵢ₋₁ axis; aᵢ is the distance between the intersection of the zᵢ₋₁ axis with the xᵢ axis and the origin of the i^{th} frame along the xᵢ axis. Or, the shortest distance between the zᵢ₋₁ and zᵢ axes; and αᵢ is the angle between the zᵢ₋₁ axis and the zᵢ axis about the xᵢ axis according to the right-hand rule.

Then, the DH transformation matrix from i^{th} frame to i−1^{th} frame is written as:

$${}_{}^{i - 1}{T}{}_{i}^{} = [ \begin{matrix}cos {θ}_{i} & - cos {α}_{i} sin {θ}_{i} & sin {α}_{i} sin {θ}_{i} & {a}_{i} cos {θ}_{i} \\ sin {θ}_{i} & cos {α}_{i} cos {θ}_{i} & - sin {α}_{i} cos {θ}_{i} & {a}_{i} sin {θ}_{i} \\ 0 & sin {α}_{i} & cos {α}_{i} & {d}_{i} \\ 0 & 0 & 0 & 1\end{matrix} ] \qquad ( 9 )$$

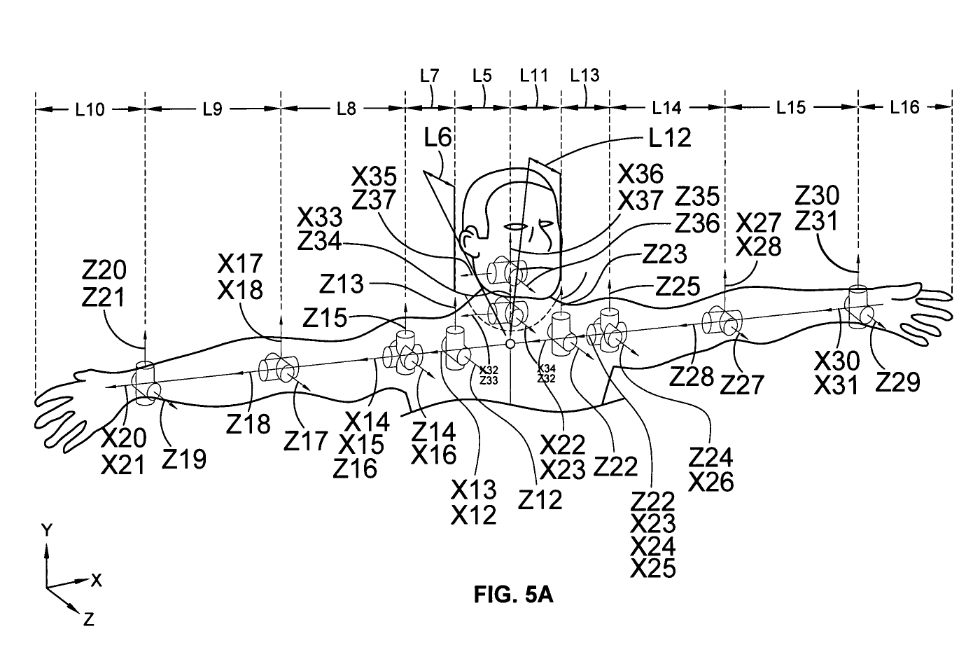

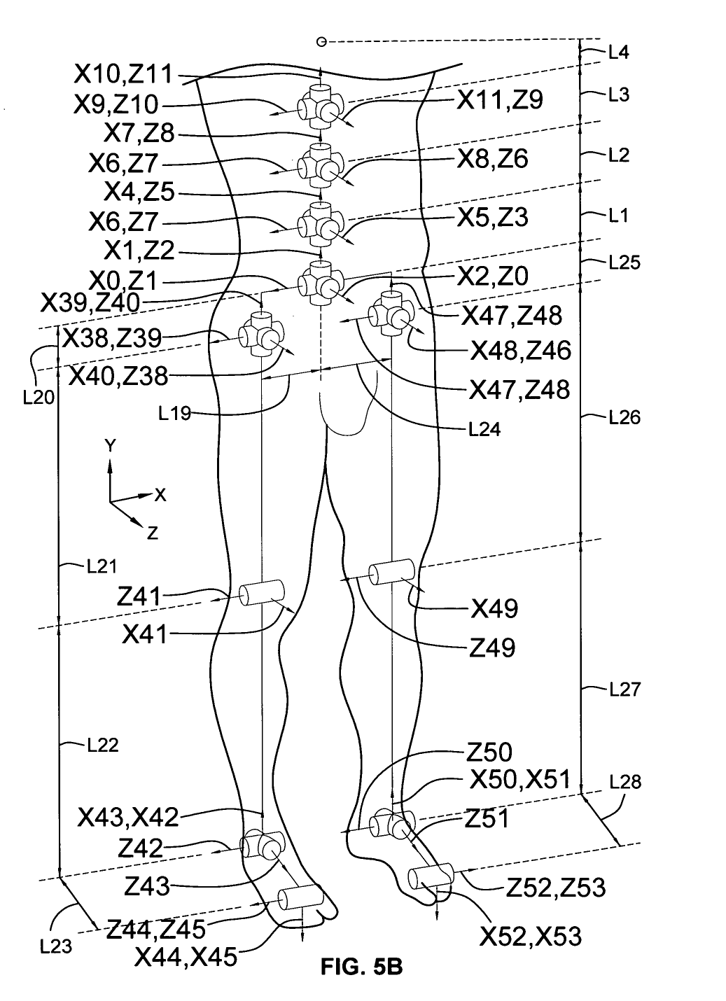

Among the four DH parameters, the rotation about the z axis is treated as the rotational DOF in the mechanical model, and the other three parameters are fixed. Therefore, each transformation has one DOF. According to the present invention, the current digital human model has 55 DOF, including 6 global DOF. The global DOF are composed of three translations and three rotations. A full-body digital human model is depicted in FIG. 5. As shown in FIG. 5, the spine, neck, shoulder and hip joint have three rotational DOF. The elbow, clavicle, ankle and wrist joint have two rotational DOF and the knee and toe joint have one rotational DOF.

The kinematics analysis in the recursive form leads to a simpler form for the transformation matrix Aᵢ. Time derivatives of the transformation matrix Ai can be obtained in the recursive form as:

$$\begin{matrix}{A}_{i} = {A}_{i - 1} {T}_{i} & ( 10 a ) \\ {B}_{i} = {\dot{A}}_{i} = {B}_{i - 1} {T}_{i} + {A}_{i - 1} \frac{\partial {T}_{i}}{\partial {q}_{i}} {\dot{q}}_{i} & ( 10 b ) \\ {C}_{i} = {\dot{B}}_{i} = {C}_{i - 1} {T}_{i} + 2 {B}_{i - 1} \frac{\partial {T}_{i}}{\partial {q}_{i}} {\dot{q}}_{i} + {A}_{i - 1} \frac{{\partial }^{2} {T}_{i}}{\partial {q}_{i}^{2}} {\dot{q}}_{i}^{2} + {A}_{i - 1} \frac{\partial {T}_{i}}{\partial {q}_{i}} {\ddot{q}}_{i} & ( 10 c ) \\ {A}_{0} = I & ( 10 d ) \\ {B}_{0} = {C}_{0} = 0 & ( 10 e )\end{matrix}$$

where q is the joint angle and Tᵢ is the link transformation matrix. The gradients of transformation matrices with respect to joint angles, joint angle velocities, and joint angle accelerations are

$$\begin{matrix} \frac{\partial {A}_{i}}{\partial {q}_{k}} = \{ \begin{matrix}{A}_{i - 1} \frac{\partial {T}_{i}}{\partial {q}_{k}} & ( k = i ) \\ \frac{\partial {A}_{i - 1}}{\partial {q}_{k}} {T}_{i} & ( k < i )\end{matrix} & ( 11 a ) \\ \frac{\partial {B}_{i}}{\partial {q}_{k}} = \{ \begin{matrix}{B}_{i - 1} \frac{\partial {T}_{i}}{\partial {q}_{k}} + {A}_{n - 1} \frac{{\partial }^{2} {T}_{i}}{\partial {q}_{k}^{2}} {\dot{q}}_{i} & ( k = i ) \\ \frac{\partial {B}_{i - 1}}{\partial {q}_{k}} {T}_{i} + \frac{\partial {A}_{i - 1}}{\partial {q}_{k}} \frac{\partial {T}_{i}}{\partial {q}_{i}} {\dot{q}}_{i} & ( k < i )\end{matrix} & ( 11 b ) \\ \frac{\partial {B}_{i}}{\partial {\dot{q}}_{k}} = \{ \begin{matrix}{A}_{i - 1} \frac{\partial {T}_{i}}{\partial {q}_{k}} & ( k = i ) \\ \frac{\partial {B}_{i - 1}}{\partial {\dot{q}}_{k}} {T}_{i} & ( k < i )\end{matrix} & ( 11 c ) \\ \frac{\partial {C}_{i}}{\partial {q}_{k}} = \{ \begin{matrix}{C}_{i - 1} \frac{\partial {T}_{i}}{\partial {q}_{k}} + 2 {B}_{i - 1} \frac{{\partial }^{2} {T}_{i}}{\partial {q}_{k}^{2}} {\dot{q}}_{i} + {A}_{i - 1} \frac{{\partial }^{3} {T}_{i}}{\partial {q}_{k}^{3}} {\dot{q}}_{i}^{2} + {A}_{i - 1} \frac{{\partial }^{2} {T}_{i}}{\partial {q}_{k}^{2}} {\ddot{q}}_{i} & ( k = i ) \\ \frac{\partial {C}_{i - 1}}{\partial {q}_{k}} {T}_{i} + 2 \frac{\partial {B}_{i - 1}}{\partial {q}_{k}} \frac{\partial {T}_{i}}{\partial {q}_{i}} {\dot{q}}_{i} + \frac{\partial {A}_{i - 1}}{\partial {q}_{k}} \frac{{\partial }^{2} {T}_{i}}{\partial {q}_{i}^{2}} {\dot{q}}_{i}^{2} + \frac{\partial {A}_{i - 1}}{\partial {q}_{k}} \frac{\partial {T}_{i}}{\partial {q}_{i}} {\ddot{q}}_{i} & ( k < i )\end{matrix} & ( 11 d ) \\ \frac{\partial {C}_{i}}{\partial {\dot{q}}_{k}} = \{ \begin{matrix}2 {B}_{i - 1} \frac{\partial {T}_{i}}{\partial {q}_{k}} + 2 {A}_{i - 1} \frac{{\partial }^{2} {T}_{i}}{\partial {q}_{k}^{2}} {\dot{q}}_{i} & ( k = i ) \\ \frac{\partial {C}_{i - 1}}{\partial {\dot{q}}_{k}} {T}_{i} + 2 \frac{\partial {B}_{i - 1}}{\partial {\dot{q}}_{k}} \frac{\partial {T}_{i}}{\partial {q}_{i}} {\dot{q}}_{i} & ( k < i )\end{matrix} & ( 11 e ) \\ \frac{\partial {C}_{i}}{\partial {\ddot{q}}_{k}} = \{ \begin{matrix}{A}_{i - 1} \frac{\partial {T}_{i}}{\partial {q}_{k}} & ( k = i ) \\ \frac{\partial {C}_{i - 1}}{\partial {\ddot{q}}_{k}} {T}_{i} & ( k < i )\end{matrix} & ( 11 f )\end{matrix}$$

Dynamic equations of motion are important constraints in the optimization-based predictive dynamics problem of human running. The biggest challenge is the number of calculations to be performed because there are many matrix multiplications and additions for kinematics analysis. Also, the optimization process can take several iterations. The number of multiplications and additions that need to be performed are significant since an optimization problem is being solved.

The Lagrange's equation is given as

$${τ}_{i} = \frac{d}{d t} ( \frac{\partial L}{\partial {\dot{q}}_{i}} ) - \frac{\partial L}{\partial {q}_{i}} \qquad ( 12 )$$

where L=K−V (kinetic energy−potential energy), q is the generalized coordinate vector (joint angles), and τᵢ is joint torque vector. If any non-conservative force exists, it goes to the left side of Equation (12) shown above. When f and h are conservative external global force and moment vectors acting on the linkage, respectively, Equation (12) can be transformed to a recursive form given as:

$$\begin{matrix}{D}_{i} = {J}_{i} {\ddot{A}}_{i}^{T} + {T}_{i + 1} {D}_{i + 1} & ( 13 a ) \\ {E}_{i} = {m}_{i} {}_{}^{i}{r}{}_{i}^{} + {T}_{i + 1} {E}_{i + 1} & ( 13 b ) \\ {F}_{i} = {}_{}^{k}{r}{}_{f}^{} {δ}_{ik} + {T}_{i + 1} {F}_{i + 1} & ( 13 c ) \\ {G}_{i} = {h}_{k} {δ}_{ik} + {G}_{i + 1} & ( 13 d ) \\ {τ}_{i} = tr [ \frac{\partial {A}_{i}}{\partial {q}_{i}} {D}_{i} ] + {g}^{T} \frac{\partial {A}_{i}}{\partial {q}_{i}} {E}_{i} + {f}_{k}^{T} \frac{\partial {A}_{i}}{\partial {q}_{i}} {F}_{i} + {G}_{i}^{T} {A}_{i - 1} {z}_{0} & ( 13 e ) \\ {D}_{n + 1} = {E}_{n + 1} = {F}_{n - 1} = {G}_{n + 1} = 0 & ( 13 f )\end{matrix}$$

where Jᵢ is the inertia matrix for link i, g is gravity vector, ⁱrᵢ is the location of the center of mass in the i^{th} local frame, ^{k}r_{f} is the location of the external force acting in the k^{th} frame, z₀=[0 0 1 0]^{T}, and δᵢₖ is Kronecker delta. The segment masses in the mechanical model are calculated using a mass distribution formula. The link length and joint locations are determined based on high resolution 3D scanned data. All the segments are assumed as slender bars, and the mass moments of inertia are calculated under this assumption.

The derivatives of equations of motion with respect to joint angles, joint angle velocities, and joint angle accelerations are:

$$\begin{matrix}\frac{\partial {τ}_{i}}{\partial {q}_{k}} = \\ \{ \begin{matrix}tr ( \begin{matrix}\frac{{\partial }^{2} {A}_{i}}{\partial {q}_{i} \partial {q}_{k}} {D}_{i} + \\ \frac{\partial {A}_{i}}{\partial {q}_{i}} \frac{\partial {D}_{i}}{\partial {q}_{k}}\end{matrix} ) + {g}^{T} \frac{{\partial }^{2} {A}_{i}}{\partial {q}_{i} \partial {q}_{k}} {E}_{i} + {f}^{T} \frac{{\partial }^{2} {A}_{i}}{\partial {q}_{i} \partial {q}_{k}} {F}_{i} + {G}_{i}^{T} \frac{\partial {A}_{i - 1}}{\partial {q}_{k}} {z}_{0} & ( k \leq i ) \\ tr ( \frac{\partial {A}_{i}}{\partial {q}_{i}} \frac{\partial {D}_{i}}{\partial {q}_{k}} ) + {g}^{T} \frac{\partial {A}_{i}}{\partial {q}_{i}} \frac{\partial {E}_{i}}{\partial {q}_{k}} + {f}^{T} \frac{\partial {A}_{i}}{\partial {q}_{i}} \frac{\partial {F}_{i}}{\partial {q}_{k}} & ( k > i )\end{matrix} & ( 14 a ) \\ \frac{\partial {τ}_{i}}{\partial {\dot{q}}_{k}} = tr ( \frac{\partial {A}_{i}}{\partial {q}_{i}} \frac{\partial {D}_{i}}{\partial {\dot{q}}_{k}} ) & ( 14 b ) \\ \frac{\partial {τ}_{i}}{\partial {\ddot{q}}_{k}} = tr ( \frac{\partial {A}_{i}}{\partial {q}_{i}} \frac{\partial {D}_{i}}{\partial {\ddot{q}}_{k}} ) & ( 14 c )\end{matrix}$$

The number of multiplications and additions for each formulation are summarized in Table 1 below.

TABLE 1
Number of multiplication and additions

| Method | Multiplications | Additions |
|---|---|---|
| Uicker (1965) | 32 ½ n⁴ + 86 5/12 | 25 n⁴ + 66 ⅓ n³ + |
| | n³ + 171 ¼ n² + 5 | 129 ½ n² + 42 |
| | ⅓ n − 128 | ⅓ n − 96 |
| Waters (1979) | 106 ½ n² + 620 | 82 n² + 514 n − |
| | ½ n − 512 | 384 |
| Hollerbach (1980) | 830 n − 592 | 675 n − 464 |

(n: number of transformation matrices)

TABLE 2
Number of multiplications and additions for n = 55

| Method | Multiplications | Additions | Total |
|---|---|---|---|
| Uicker (1965) | 312293722 | 240195803 | 552489525 |
| Waters (1979) | 355778 | 275936 | 631714 |
| Hollerbach (1980) | 45058 | 36661 | 81719 |

The order of calculations for the three formulations noted previously can be observed in Table 1. For a system with small DOF, the total computational time with the three formulations may not be too different. However, for a model with a large number of DOF such as the human digital model with 55 DOF, the number of calculations can be significantly different. This can have a significant impact on the efficiency of the entire optimization process. It is clear that the recursive formulation is the most suitable for digital human modeling, and it is used for the running problem.

The equations of motion are verified by the forward dynamics process using a commercial general-purpose multi-body dynamics software code, such as ADAMS. The single pendulum problem as shown in FIG. 6 was solved using ADAMS. FIG. 6 depicts the single pendulum model in which mass is 0.5 kg, length is 0.4 m, and it is assumed to be a slender bar. The equation of motion is given by:

$$I \ddot{q} + m g \frac{l}{2} cos q = τ \qquad ( 15 )$$

The initial position is q=0, and the ADAMS results are shown in FIG. 7.

Since it is a free vibrations problem, there should not be non-conservative joint torque (τ=0). By using ADAMS, the joint torque is indeed obtained as zero, thus verifying the current equations of motion formulation.

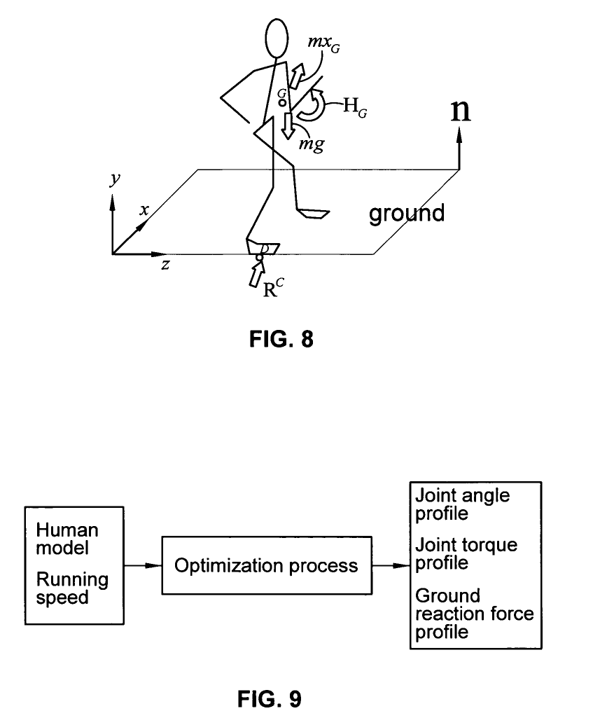

Another important consideration for the running problem is the dynamic stability of the motion. The most common constraint to achieve stability for biped gait analysis is the ZMP constraint in the support phase. As shown in FIG. 8, point D is ZMP, which needs to be determined. The resultant moment about the ZMP by inertia, gravity, and external force (“IGF”) is given as:

M_{D}^{IGF}=x_{DG}×mg−x_{DG}×m\ddot{x}_{G}−\dot{H}_{G} (16)

where \dot{H}_{G} is rate of angular momentum about the center of mass of the system. The resultant moment about the point O is:

M_{O}^{IGF}=x_{OG}×mg_{G}−x_{OG}×m\ddot{x}_{G}−\dot{H}_{G} (17)

Then Equation (17) can be written as

M_{D}^{IGF}=M_{O}^{IGF}−x_{OD}×R^{IGF} (18)

From the condition that the tripping moment by IGF measured at the D is zero, the equations are:

$$\begin{matrix}n \times {M}_{D}^{IGF} = n \times {M}_{O}^{IGF} - n \times ( {x}_{OD} \times {R}^{IGF} ) \\ = n \times {M}_{O}^{IGF} - ( n \cdot {R}^{IGF} ) OD + ( n \cdot {x}_{OD} ) {R}^{IGF} \\ = 0\end{matrix} \qquad ( 19 )$$

where n is a unit vector that is normal to ground plane. Then, the ZMP location is obtained as:

$${x}_{OD} = \frac{n \times {M}_{O}^{IGF}}{n \cdot {R}^{IGF}} \qquad ( 20 )$$

The ZYM constraint is usually imposed for the upper-body motion to be compensated by the lower-body motion. From Equation (16), the yawing moment about the ZMP D is obtained as:

$$\begin{matrix}{Y}_{D}^{IGF} = {M}_{D}^{IGF} \cdot n \\ = {{\sum }_{i}}^{{n}_{body}} [ {x}_{DGi} \times ( {m}_{i} g - {m}_{i} {\ddot{x}}_{Gi} ) - {\dot{H}}_{{G}_{i}} ] \cdot n \\ = {{\sum }_{i}}^{{n}_{body}} [ {x}_{DGi} \times ( {m}_{i} g - {m}_{i} {\ddot{x}}_{Gi} ) ] \cdot n\end{matrix} \qquad ( 21 )$$

where \dot{H}_{Gi} is assumed to be zero.

The joint angle profiles that minimize an energy cost function need to be determined. It is assumed that the running motion is completely periodic and symmetric and that there are two phases, support and flight. To solve this optimization problem, a skeletal model of the human and the running speed are used as input. Through the optimization process, joint angle profile, joint torque profile, and contact force profile are obtained as output, as shown in FIG. 9.

The design variables are:

DV:q (22)

where q is joint angle profiles. The cost function is:

f=∫₀^{t}τ^{T}τdt (23)

Equation (23) is proportional to the mechanical energy, which is a reasonable criterion to minimize.

Most constraints are motivated by the digital human walking formulation. The constraints include: joint limits, ground penetration, foot location of ground contact point, impact constraint (zero velocity at foot strike), ZMP during support phase, ZYM, and symmetry condition.

There is a flight phase in human running and at the end of this flight phase, there is impact. In this impact, there is the sudden change of joint angle velocities. Therefore, this sudden change of joint angle velocities results in an impulsive force at the foot impact. To handle the impact stage in the current implementation, the heel velocity is set to zero when the foot strike occurs.

\dot{x}ᵢ(t)=0, 0≦t≦T, iεcontact (24)

To implement the zero moment point constraint in the current formulation, the x-z plane as the ground is considered as shown in FIG. 6. In other words, the normal vector n is [0, 1, 0]^{T}. In this case, the ZMP calculation from Equation (20) can be simplified as:

$$\begin{matrix}{z}_{zmp} = \frac{{\sum }_{i}^{n} {m}_{i} ( {\ddot{y}}_{i} + g ) {z}_{i} - {m}_{i} {\ddot{z}}_{i} {y}_{i} + {J}_{i} {\ddot{q}}_{ix}}{{{\sum }_{i}}^{n} {m}_{i} ( {\ddot{y}}_{i} + g )} & ( 25 a ) \\ {x}_{zmp} = \frac{{{\sum }_{i}}^{n} {m}_{i} ( {\ddot{y}}_{i} + g ) {x}_{i} - {m}_{i} {\ddot{x}}_{i} {y}_{i} + {J}_{i} {\ddot{q}}_{iz}}{{\sum }_{i}^{n} {m}_{i} ( {\ddot{y}}_{i} + g )} & ( 25 b )\end{matrix}$$

Here, the zero moment point is simply a point where the moments about the x and z axes due to IGF are zero.

The yawing moment constraint is imposed as:

|Y_{D}^{IGF}|≦Y_{D}^{U} (26)

where Y_{D}^{IGF} is the resultant yawing moment about the y axis and Y_{D}^{U} is an upper bound. In the current implementation, Y_{D}^{U} is set to zero. From Equation (21), the zero yawing moment constraint is simplified with n=[0, 1, 0]^{T} as:

$${Y}_{D}^{IGF} = {\sum }_{i}^{{n}_{body}} {m}_{i} [ ( {z}_{i} - {z}_{zmp} ) {\ddot{x}}_{i} - ( {x}_{i} - {x}_{zmp} ) {\ddot{z}}_{i} ] \qquad ( 27 )$$

The step length and flight time were formulated as a function of running speed and running frequency. The step length sl is given as:

$$s l = 0.1394 + ( 0.00465 + level ) v \sqrt{\frac{body\_height}{1.8}} \qquad ( 28 )$$

where v is running speed (m/min), level is the level of expertise in running (−0.001 as poor≦level≦0.001 as skilled), body_height is the height of the human body. The flight time t_{flight} is given as:

t_{flight}=−0.675×10⁻³−(0.15×10⁻³+level)sf+0.542×10⁻⁵sf² (29a)

t_{flight}=−8.925+(0.131+level)sf−0.623×10⁻³sf²+0.979×10⁻⁶sf³ (29b)

where sf is step frequency (steps/min, sf=v/sl). Equation (29a) is used when sf is 0˜180 steps/min, and Equation (29b) is used when sf is 180˜230 steps/min.

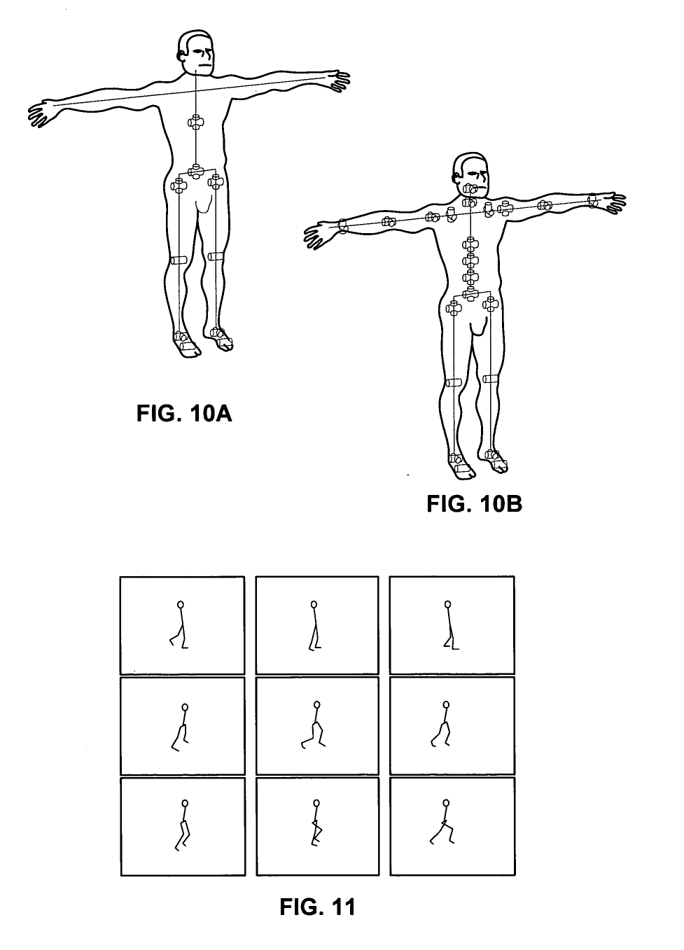

To evaluate the formulation, human digital models with and without arms were used. The model without arms has 26 DOF (6 global DOF, 7 DOF for each leg, and 6 DOF for spine). FIG. 10(a) depicts joints in the model without arms, and FIG. 10(b) depicts joints in the full-body model with 55 DOF.

The number of control points is taken as five for each DOF. Thus, the total number of design variables is 130 for the model without arms and 275 for full-body model.

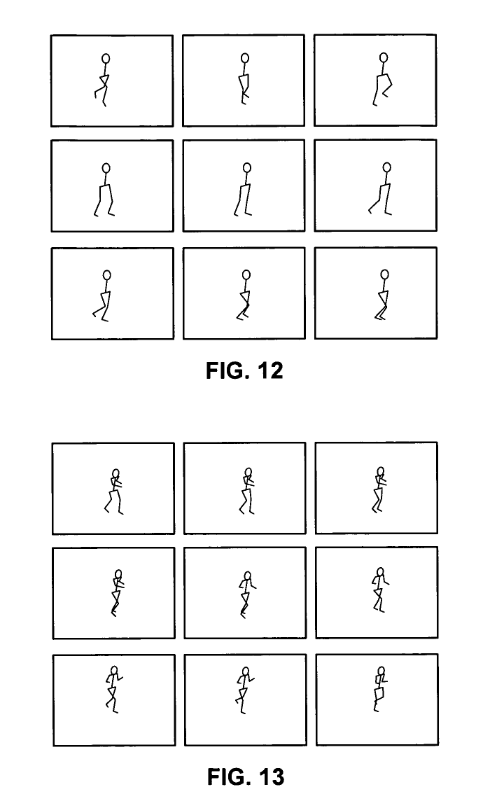

FIG. 11 is a graphical illustration of a digital human model running at a speed of 2 m/s. The step length is 0.8 m, and the model without the arms was used for this simulation. FIG. 12 is a snapshot for the case where a backpack is included. The model without arms was used for this case as well. The running speed was 1.8 m/s and step length was 0.6 m. The backpack mass was 10.20 kg (100 N).

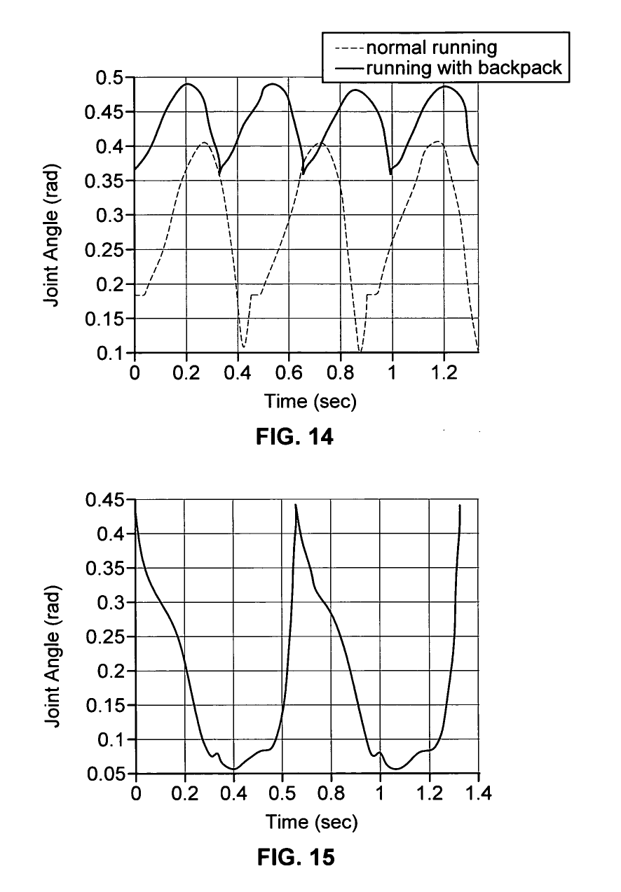

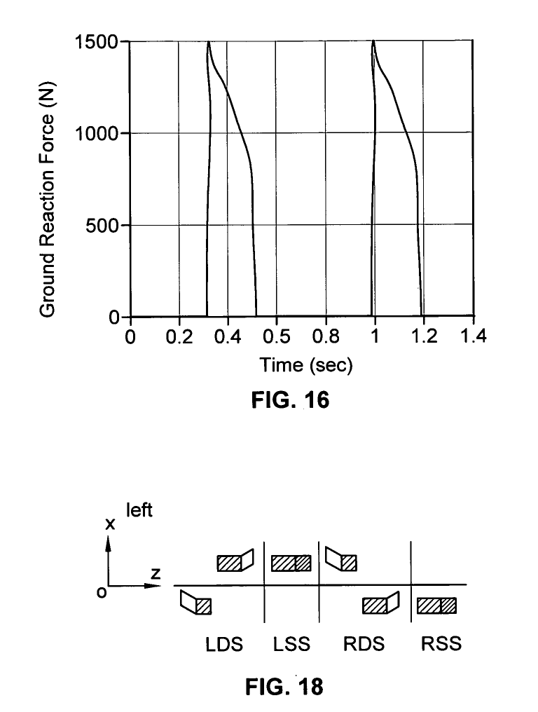

FIG. 13 is a graphical illustration of a digital human model running with the full body model. In this simulation, the initial and end points were specified for the elbow as additional constraints. FIG. 14 is a graph of results illustrating a comparison of the joint angles for the spine between normal running and running with backpack as shown in FIG. 11 and FIG. 12 respectively. FIG. 15 and FIG. 16 are a right knee joint angle profile and a ground reaction force profile respectively for the full body digital human model.

In summary, the task of digital human running was formulated as an optimization problem. Using the optimization process, it is possible to predict dynamic motion such as joint angle profiles as well as the corresponding joint torques. A predictive dynamics approach was used where there was no need to integrate the equations of motion, as with the forward dynamics formulation. B-spline interpolation was used for discretization along the time axis, and the Denavit-Hartenberg method was used for kinematics analysis of the mechanical system. For dynamic equilibrium, the recursive Lagrange method was used to reduce the order of computations. For dynamic stability, zero moment point and zero yawing moment constraints were used. To formulate the impact stage, the zero velocity at foot strike was used. The mechanical structure of a digital human model was developed as a model without arms with 26 DOF, and a full body model with 55 DOF. As a separate case, an external load was applied as a backpack. With the full body model, the upper-body motion, particularly the arm motion, was observed. The step length and flight time were given as functions of running speed and running frequency, respectively.

In another embodiment, the present invention is formulated as an optimization-based predictive dynamics problem for walking. In this embodiment, an optimization-based approach for simulating the walking motion of a digital human model is presented. The spatial skeletal human digital model having 55 DOF is used with design variables as joint angle profiles. Walking motion is generated by minimizing the mechanical energy subjected to basic physical and kinematical constraints. A formulation for symmetric and periodic normal walking is developed including taking into account a backpack and ground reaction forces, and the effects of the backpack on normal walking.

Again, the kinematics relation of a spatial human model is represented by the DH method, in which 4×4 homogeneous transformation matrices relate two adjacent coordinate systems. The DH transformation matrix includes rotation and translation and is a function of four parameters: θ_{I}, dᵢ aᵢ and aᵢ and as shown in Equation (30) below:

$${}_{}^{i - 1}{T}{}_{i}^{} = [ \begin{matrix}cos {θ}_{i} & - cos {α}_{i} sin {θ}_{i} & sin {α}_{i} sin {θ}_{i} & {a}_{i} cos {θ}_{i} \\ sin {θ}_{i} & cos {α}_{i} sin {θ}_{i} & - sin {α}_{i} sin {θ}_{i} & {a}_{i} sin {θ}_{i} \\ 0 & sin {α}_{i} & cos {α}_{i} & {d}_{i} \\ 0 & 0 & 0 & 1\end{matrix} ] \qquad ( 30 )$$

In order to obtain a systematic representation of a serial kinematics chain, q εRⁿ is defined as the vector of n-generalized coordinates, the joint angles. The position vector of a point of interest in the Cartesian space can be written in terms of the joint variables as X=X(q). In this form, the augmented 4×1 vectors ⁰rₙ and rₙ are defined using the global Cartesian vector X(q) and the local Cartesian vector Xₙ as:

$${0}_{{r}_{n}} = [ \begin{matrix}X ( q ) \\ 1\end{matrix} ] ; {r}_{n} [ \begin{matrix}{X}_{n} \\ 1\end{matrix} ] \qquad ( 31 )$$

where Xₙ is the position of a point with respect to the n^{th} coordinate system. Using these vectors, ⁰rₙ can be related to rₙ as follows:

$$\begin{matrix}{}_{}^{0}{r}{}_{n}^{} = {}_{}^{0}{T}{}_{n}^{} ( q ) {r}_{n} \\ where & ( 32 ) \\ {}_{}^{0}{T}{}_{n}^{} ( q ) = {\prod }_{i = 1}^{n} {}_{}^{i - 1}{T}{}_{i}^{} = {}_{}^{0}{T}{}_{1}^{} ( {q}_{1} ) {}_{}^{1}{T}{}_{2}^{} ( {q}_{2} ) … {}_{}^{n - 1}{T}{}_{n}^{} ( {q}_{n} ) & ( 33 )\end{matrix}$$

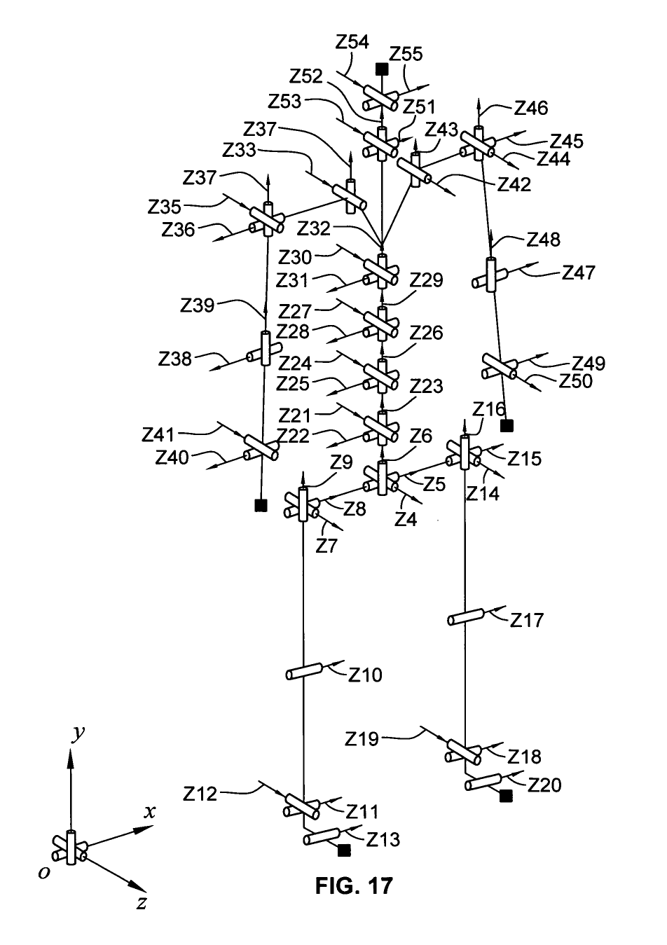

A spatial digital human skeletal model with 55 DOF, as shown in FIG. 17, is considered. The digital human model consists of six physical branches and one virtual branch. The physical branches include the right leg, the left leg, the spine, the right arm, the left arm, and the head. In these branches, the right leg, the left leg, and the spine start from the pelvis, while the right arm, left arm, and head start from the ending joint of the spine (z₃₀, z₃₁, z₃₂). The virtual branch contains six global DOFs, including three global translations (z₁, z₂, z₃) and three global rotations (z₄, z₅, z₆) located at the pelvis, and move the model from the origin (o-xyz) to the current pelvic position (z₄, z₅, z₆).

In this process, 4×4 transformation matrices Aⱼ, Bⱼ, and Cⱼ are defined to represent the recursive position, velocity, and acceleration for the j^{th} joint respectively. Given the link transformation matrix (Tⱼ) and the kinematics state variables for each joint (qⱼ, \dot{q}ⱼ, and \ddot{q}ⱼ), then for j=1 to n:

$$\begin{matrix}{A}_{j} = {T}_{1} {T}_{2} {T}_{3} … {T}_{j} = {A}_{j - 1} {T}_{j} & ( 34 ) \\ {B}_{j} = {\dot{A}}_{j} = {B}_{j - 1} {T}_{j} + {A}_{j - I} \frac{\partial {T}_{j}}{\partial {q}_{j}} {\dot{q}}_{j} & ( 35 ) \\ \begin{matrix}{C}_{j} = {\dot{B}}_{j} \\ = {\ddot{A}}_{j} \\ = {C}_{j - 1} {T}_{j} + 2 {B}_{j - 1} \frac{\partial {T}_{j}}{\partial {q}_{j}} {\dot{q}}_{j} + \\ {A}_{j - I} \frac{{\partial }^{2} {T}_{j}}{\partial {q}_{j}^{2}} {\dot{q}}_{j}^{2} + {A}_{j - 1} \frac{\partial {T}_{j}}{\partial {q}_{j}} {\ddot{q}}_{j}\end{matrix} & \\ {A}_{0} = [ I ] and {B}_{0} = {C}_{0} = [ 0 ] . & ( 36 )\end{matrix}$$

After obtaining all transformation matrices Aj, Bj, and Cj, the global position, velocity, and acceleration of a point in the Cartesian coordinate system can be calculated using the following formulas:

⁰rₙ=Aₙrₙ; ⁰\dot{r}ₙ=Bₙrₙ; ⁰\ddot{r}ₙ=Cₙrₙ (37)

where rₙ represents the augmented local coordinates of the point in the n^{th} coordinate system.

Based on forward recursive kinematics, the backward recursion for the dynamic analysis is accomplished by defining a 4×4 transformation matrix Dᵢ and 4×1 transformation matrices Eᵢ, Fᵢ, and Gᵢ, as follows.

Given the mass and inertia properties of each link, the external force fₖ^{T}=[fₓ, f_{y}, f_{z} 0], and the moment hₖ^{T}=[hₓ h_{y} h_{z} 0] for link k (1≦k≦n) defined in the global coordinate system, the joint actuation torques τᵢ for i=n to 1 are computed as follows:

$$\begin{matrix}{τ}_{i} = tr [ \frac{\partial {A}_{i}}{\partial {q}_{i}} {D}_{i} ] + {g}^{T} \frac{\partial {A}_{i}}{\partial {q}_{i}} {E}_{i} + {f}_{k}^{T} \frac{\partial {A}_{i}}{\partial {q}_{i}} {F}_{i} + {G}_{i}^{T} + {A}_{i - 1} {z}_{0} & ( 38 ) \\ {D}_{i} = {J}_{i} {C}_{i}^{T} + {T}_{i + 1} {D}_{i + 1} & ( 39 ) \\ {E}_{i} = {m}_{i} {}_{}^{i}{r}{}_{i}^{} + {T}_{i + 1} {E}_{i + 1} & ( 40 ) \\ {F}_{i} = {}_{}^{k}{r}{}_{f}^{} {δ}_{ik} + {T}_{i + 1} {F}_{i + 1} & ( 41 ) \\ {G}_{i} = {h}_{k} {δ}_{ik} + {G}_{i + 1} & ( 42 )\end{matrix}$$

where Dₙ₊₁=Eₙ₊₁=Fₙ₊₁=Gₙ₊₁=[0]; Jᵢ is the inertia matrix for link i; mᵢ is the mass of link i; g is the gravity vector; ⁱrᵢ is the location of center of mass of link i in the local frame i; ^{k}r_{f} is the position of the external force in the local frame k; z₀=[0 0 1 0]^{T}, and δᵢₖ is Kronecker delta.

The first term in the torque expression is the inertia and Coriolis torque, the second term is the torque due to gravity, the third term is the torque due to external force, and the fourth term represents the torque due to the external moment.

The gradients of the torque for the 3D human mechanical system with respect to the state variables:

$$\frac{\partial {τ}_{i}}{\partial {q}_{k}} , \frac{\partial {τ}_{i}}{\partial {\dot{q}}_{k}} , \frac{\partial {τ}_{i}}{\partial {\ddot{q}}_{k}} \qquad ( 43 )$$

where i=1 to n; k=1 to n can be evaluated in a recursive way using the foregoing recursive Lagrangian dynamics formulation of Equations (34) through (42) immediately shown above.

$$\begin{matrix}\frac{\partial {τ}_{i}}{\partial {q}_{k}} = \{ \begin{matrix}\begin{matrix}tr ( \frac{{\partial }^{2} {A}_{i}}{\partial {q}_{i} \partial {q}_{k}} {D}_{i} + \frac{\partial {A}_{i}}{\partial {q}_{i}} \frac{\partial {D}_{i}}{\partial {q}_{k}} ) + {g}^{T} \frac{{\partial }^{2} {A}_{i}}{\partial {q}_{i} \partial {q}_{k}} {E}_{i} + \\ {f}^{T} \frac{{\partial }^{2} {A}_{i}}{\partial {q}_{i} \partial {q}_{k}} {F}_{i} + {G}_{i}^{T} \frac{\partial {A}_{i - 1}}{\partial {q}_{k}} {z}_{0}\end{matrix} & ( k \leq i ) \\ tr ( \frac{\partial {A}_{i}}{\partial {q}_{i}} \frac{\partial {D}_{i}}{\partial {q}_{k}} ) + {g}^{T} \frac{\partial {A}_{i}}{\partial {q}_{i}} \frac{\partial {E}_{i}}{\partial {q}_{k}} + {f}^{T} \frac{\partial {A}_{i}}{\partial {q}_{i}} \frac{\partial {F}_{i}}{\partial {q}_{k}} & ( k > i )\end{matrix} & ( 44 ) \\ \frac{\partial {τ}_{i}}{\partial {\dot{q}}_{k}} = tr ( \frac{\partial {A}_{i}}{\partial {q}_{i}} \frac{\partial {D}_{i}}{\partial {\dot{q}}_{k}} ) & ( 45 ) \\ \frac{\partial {τ}_{i}}{\partial {\ddot{q}}_{k}} = tr ( \frac{\partial {A}_{i}}{\partial {q}_{i}} \frac{\partial {D}_{i}}{\partial {\ddot{q}}_{k}} ) & ( 46 )\end{matrix}$$

According to the present invention, normal walking is assumed to be symmetric and cyclic. A complete gait cycle includes two continuous steps, otherwise known as one stride. The step is further divided into two phases, the single support phase and the double support phase.

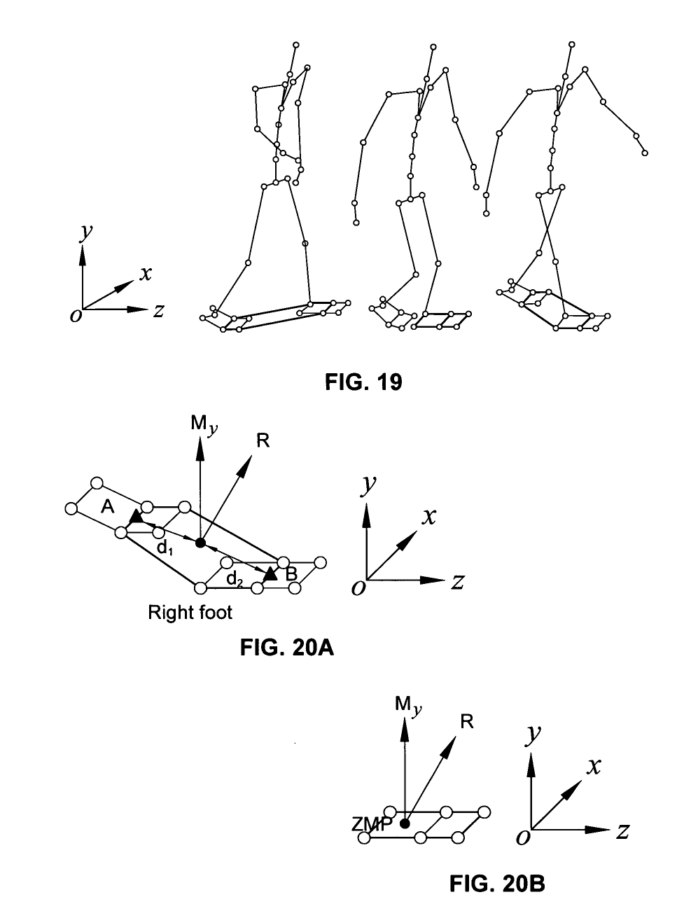

Considering the foot flexion, the two support phases can be detailed into four basic supporting modes: right foot single support (“RSS”), left foot single support (“LSS”), right foot leading double support (“RDS”) and left foot leading double support (“LDS”), as shown in FIG. 18. The gait cycle starts from the left heel strike (“LDS”) and goes through the right swing (“LSS”), the right heel strike (“RDS”), and the right swing (“RSS”) before coming back to left heel strike (“LDS”) again. By applying the symmetry conditions, it is possible to consider only one step in a normal steady gait cycle instead of considering two steps. As a result, the computational costs are significantly minimized, as illustrated in FIG. 19.

In the single support phase, one foot supports the whole body and the ZMP stays in the foot area so that ground reaction forces (“GRF”) can be applied at the ZMP directly. However, in the double support phase, the ZMP is located between the two supporting feet, and therefore, the resultant GRF needs to be distributed into the two feet appropriately. This distribution process can be treated as a sub-optimization problem. In order to simplify this process, a linear relationship is used to distribute GRF in the double support phase as shown in FIG. 20(a).

In FIG. 20(a), triangular points A and B are center points of the middle joints of the feet and d₁ and d₂ are the distances from the ZMP to points A and B, respectively. Note that there are only normal moment M_{y} and resultant force R (Rₓ, R_{y}, R_{z}) at ZMP, as M_{z}, and Mₓ vanish due to the assumption of no-slip condition. The GRF is linearly decomposed to the central points as follows:

$$\begin{matrix}{M}_{y 1} = \frac{{d}_{2}}{{d}_{1} + {d}_{2}} {M}_{y} ; & {R}_{1} = \frac{{d}_{2}}{{d}_{1} + {d}_{2}} R \\ {M}_{y 2} = \frac{{d}_{1}}{{d}_{1} + {d}_{2}} {M}_{y} ; & {R}_{2} = \frac{{d}_{1}}{{d}_{1} + {d}_{2}} R\end{matrix} \qquad ( 47 )$$

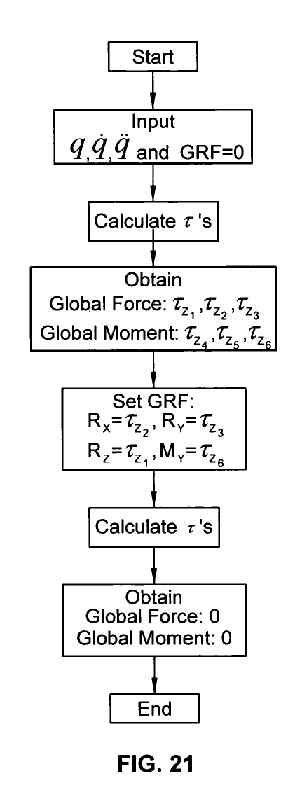

A two-step algorithm is used to calculate GRF as depicted in the following flowchart of FIG. 21. First, given current state variables, the recursive Lagrangian dynamics of the whole body is used to calculate torques without GRF. The resulting global forces in the virtual branch are not zero because of excluding GRF, however, the moments about the x and z at ZMP are zero due to the ZMP calculation.

Second, GRF are assumed to be acting at the ZMP. Considering the equilibrium of the global forces and moments in the virtual branch with the ground reaction forces and moments, three forces and moment about the y axis at the ZMP are calculated. The GRF are then treated as external forces and moments for the entire model and the updated joint torques are recovered from the equations of motion.

In the current formulation, the design variables are the joint profiles qᵢ(t) for a symmetric and cyclic gait motion. Besides the joint profiles, the initial posture is also optimized. Also, the final posture should satisfy the symmetry condition with the initial posture so that continuous joint profiles are generated. Meanwhile, the torque profiles are calculated from joint profiles using the recursive Lagrangian dynamics equations.

The energy-related performance measure, the integral of the squares of all joint torques, is used as the objective function for the walking motion prediction that is defined as:

$$Minimize f ( q ) = {\int }_{t = 0}^{T} {\sum }_{i = 1}^{ndof} {τ}_{i}^{2} ( q ) d t \qquad ( 48 )$$

where ndof is the number of degrees of freedom.

Constraints such as joint angle limits, ground penetration, foot contacting positions, ZMP stability, pelvic velocity, soft impact, knee flexion at mid-swing, symmetry conditions, and the arm-leg coupling ash are proposed and implemented to satisfy laws of physics and boundary conditions through out the normal walking process.

The joint angle limits that account for the physical range of motion are obtained from experiments:

q^{L}≦q(t)≦q^{U}, 0≦t≦T (49)

where q^{L} is the lower limit on the joint angles and q^{U} is the upper limit on the joint angles.

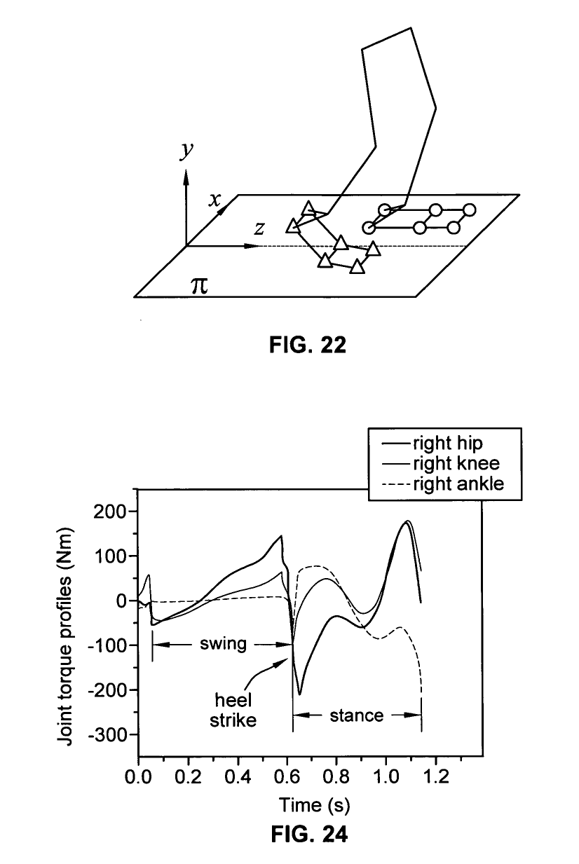

Bipedal walking is characterized with unilateral contact in the whole process. While the foot is in contact with the ground, the height of the contacting points is zero. The other points are above the ground and the height greater than zero as shown in FIG. 22:

$$\begin{matrix}{y}_{i} ( t ) = 0 , & 0 \leq t \leq T , & i ∈ contact \\ {y}_{i} ( t ) > 0 , & 0 \leq t \leq T , & i ∉ contact\end{matrix} \qquad ( 50 )$$

Since the step length L is given, the foot contacting position is known and specified at each time.

xᵢ(t)=\tilde{x}ᵢ, iεcontact (51)

where \tilde{x}ᵢ is the specified contacting position.

The stability is achieved by constraining the ZMP to be in the foot supporting region (“FSR”):

z_{ZMP}(t)εFSR, x_{ZMP}(t)εFSR 0≦t≦T (52)

The pelvic translational velocity along the walking direction in normal walking is stable and almost a constant (V) quantity; this is treated as a constraint:

żₚₑₗᵥᵢₛ(t)=V 0≦t≦T (53)

The landing impact issue is taken into account by imposing velocity of contacting points to be zero. This is the so-called soft impact, which makes the gait motion gentle and smooth:

$${\dot{x}}_{i} ( t ) = 0 , {\dot{y}}_{i} ( t ) = 0 , {\dot{z}}_{i} ( t ) = 0 , \\ 0 \leq t \leq T , i ∈ contact \qquad ( 54 )$$

Knee flexion at mid-swing is one of the six determinants of normal gait. Biomechanical experiments show that the maximum knee flexion of normal gait is around 60 degrees regardless of age and gender. In addition, this also ensures enough space between the foot and the ground to avoid collision. This constraint is imposed as:

qₖₙₑₑ(t)=60+ε, t=t_{midswing} (55)

where ε is a small range of motion.

The gait simulation starts from the left heel strike and ends with the right heel strike. The initial and final postures should satisfy the symmetry conditions. These conditions are expressed as:

qᵢ_{_{—}}_{left}(0)=qᵢ_{_{—}}_{right}(T)

qⱼₓ(0)=qⱼₓ(T),

q_{jy}(0)=−q_{jy}(T),

q_{jz}(0)=−q_{jz}(T), (56)

where x, y, z are the global axes, and the subscript i represents the DOF of the leg, arm and shoulder joints and j represents other DOF.

The arm-leg coupling motion guarantees that the swing of the arm and leg on the same side are in the opposite directions:

q_{right}_{_{—}}ₐᵣₘ(t)q_{right}_{_{—}}_{leg}(t)≦0,

q_{left}_{_{—}}ₐᵣₘ(t)q_{left}_{_{—}}_{leg}(t)≦0, 0≦t≦T (57)

For the optimization problem, the entire time domain is discretized by B-spline curves, which are defined by a set of control points P and time grid points or knots t. A B-spline is a numerical interpolation method that has many important properties, such as continuity, differentiability, and local control. These properties, especially differentiability and local control, make B-splines competent to represent joint angle trajectories, which require smoothness and flexibility.

Let t={t₀, t₁ . . . , tₘ} be a non-decreasing sequence of real numbers, i.e., tᵢ≦tᵢ₊₁, i=0, . . . , m−1. The tᵢ are called knots, and they are non-decreasingly spaced for a B-spline. A cubic B-spline is defined as:

$$q ( t ) = {\sum }_{j = 0}^{nct} {N}_{j , 4} ( t ) {P}_{j} ; 0 \leq t \leq T \qquad ( 58 )$$

where the {Pⱼ}, j=0, . . . , nct are the (nct+1) control points, and the {N_{j,4}(t)}are the cubic B-spline basis functions defined on the non-decreasing knot vector.

Since the first-order and second-order derivatives of the joint angles are needed in the optimization problem, the derivatives of a cubic B-spline curve can be easily obtained because only the basis functions are functions of time. Therefore, the original continuous variable optimization problem is transformed into a parameterized optimization problem by using Equations (58) immediately above and the following two equations:

$$\begin{matrix}\dot{q} ( t ) = {\sum }_{j = 0}^{nct} {\dot{N}}_{j , 4} ( t ) {P}_{j} ; 0 \leq t \leq T & ( 59 ) \\ \ddot{q} ( t ) = {\sum }_{j = 0}^{nct} {\ddot{N}}_{j , 4} ( t ) {P}_{j} ; 0 \leq t \leq T & ( 60 )\end{matrix}$$

q, \dot{q}, and \ddot{q} are functions of t and P; therefore, torque τ=τ(t,P) is an explicit function of the knot vector and control points from the equation of motion. Thus, the derivative of a torque τ with respect to the control points is computed using the chain rule as:

$$\frac{\partial τ}{\partial {P}_{i}} = \frac{\partial τ}{\partial q} \frac{\partial q}{\partial {P}_{i}} + \frac{\partial τ}{\partial \dot{q}} \frac{\partial \dot{q}}{\partial {P}_{i}} + \frac{\partial τ}{\partial \ddot{q}} \frac{\partial \ddot{q}}{\partial {P}_{i}} \qquad ( 61 )$$

Finally, five control points are used for each DOF providing 5×55=275 design variables and 629 nonlinear constraints.

A large-scale sequential quadratic programming (“SQP”) approach is used to solve the nonlinear optimization problem of normal walking. To use the algorithm, cost and constraint functions and their gradients are calculated. The foregoing developed recursive kinematics and dynamics formulations provide accurate gradients to improve the computational efficiency of the numerical optimization algorithm. The appropriate normal walking parameters such as velocity and step length are obtained from biomechanics literature. In addition to normal walking, the present invention also considers situations where people walk and carry backpacks with various weights, for example, 0 lbs, 20 lbs, and 40 lbs.

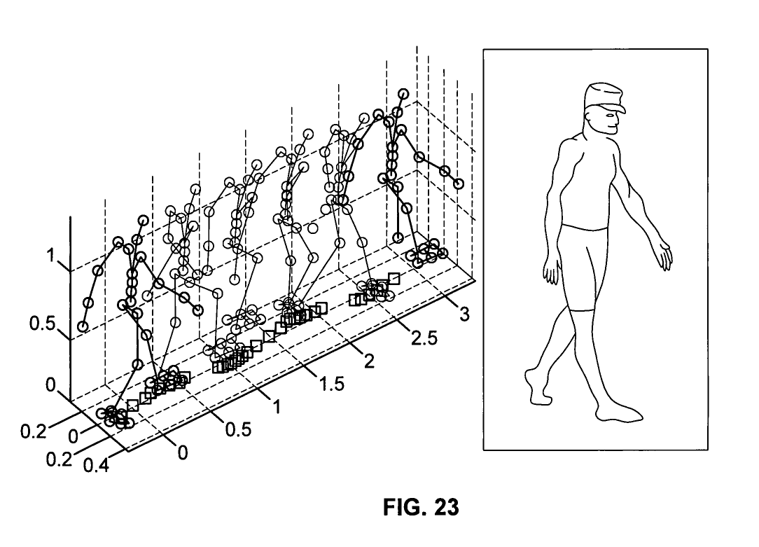

To solve a normal gait motion, a pair of parameters is input, for example, normal walking velocity V=1.2 m/s and step length L=0.7 m. FIG. 23 shows the resulting stick diagram of a 3D human walking on flat ground. As expected, correct bending of knee occurs to avoid collision, and the arms swing to balance the leg swing and GRF. The continuity condition is satisfied to generate a smooth walking motion while the initial posture is also optimized. It is important to note that the spine remains upright automatically to reduce energy expenditure in the walking motion. In addition, the ZMP trajectory is smooth and stays in the support region

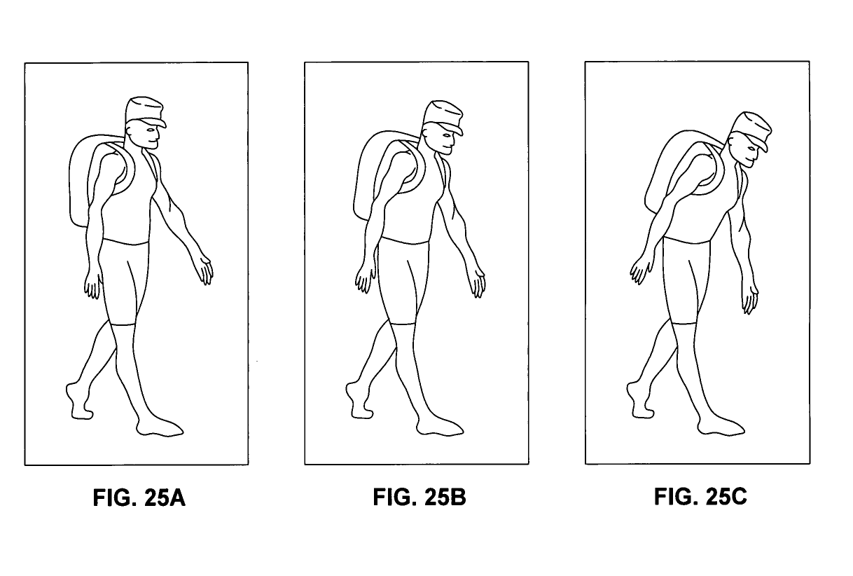

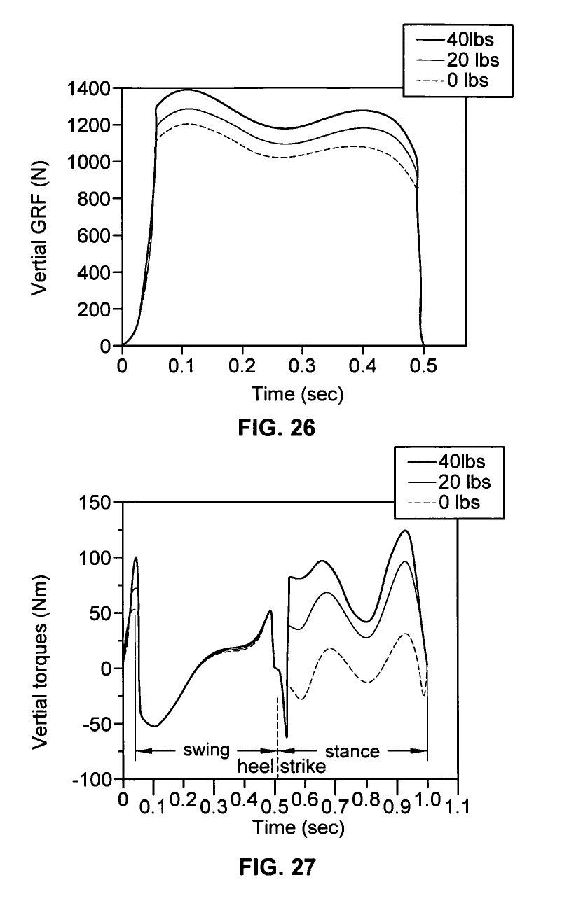

FIG. 24 depicts the torque profiles of the right hip, right knee, and right ankle. It is evident that the ankle torque is quite small in the swing phase and that the peak value occurs at the heel strike. In this process, a shoulder backpack is considered in the walking motion prediction with the walking velocity V=1.0 m/s and step length L=0.5 m. Three cases are tried with varying backpack weights: 0 lbs, 20 lbs, and 40 lbs. The walking motion is compared using digital human models as shown in FIG. 25, and reasonable spine bending is observed. FIG. 26 is a graph of results of vertical ground reaction forces, where the results show a heavier backpack results in larger GRF and FIG. 27 is a graph of results of knee torques.

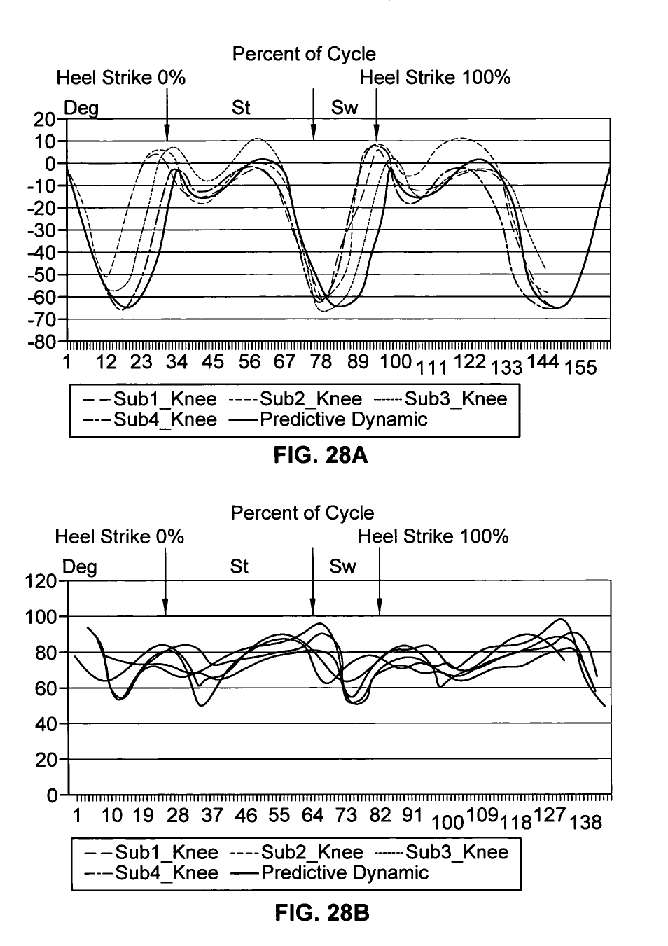

Two predicted walking determinants, the knee and ankle joint angle profiles, were chosen for comparison purposes with data obtained from four normal subjects as shown in FIG. 28. The data predicted by the dynamic model for the knee and ankle joints were also added to FIG. 28. The graphs clearly show that the predicted trend is in the range of normal in terms of joint angle amplitude and time history.

In this paper, the motion prediction of the normal gait of a 55 DOF digital human model was presented. Based on the experimental data and biomechanical requirements, the results have demonstrated the ability of the proposed methodology to predict realistic human motions with the complex spatial skeleton model. The normal gait was treated as a cyclic and symmetric motion with repeatable initial and final postures. The motion planning was formulated as a large-scale nonlinear programming problem. Joint profiles were discretized using cubic B-splines, and the corresponding control points were treated as unknowns. The energy-related objective function, which represents the integral of squares of all joint torques, was minimized. The arm motion was incorporated by considering the role of the yawing moment and the arm-leg coupling motion constraints in the formulation. The walking determinants were obtained to verify the gait motion. The effect of backpack on gait motion was studied, and plausible posture responses were achieved. The kinetic data such as joint torque and ground reaction forces were also analyzed. The limitation of current gait formulation is that only energy-saved motion is generated and the walking motion is on a level ground with symmetry conditions.

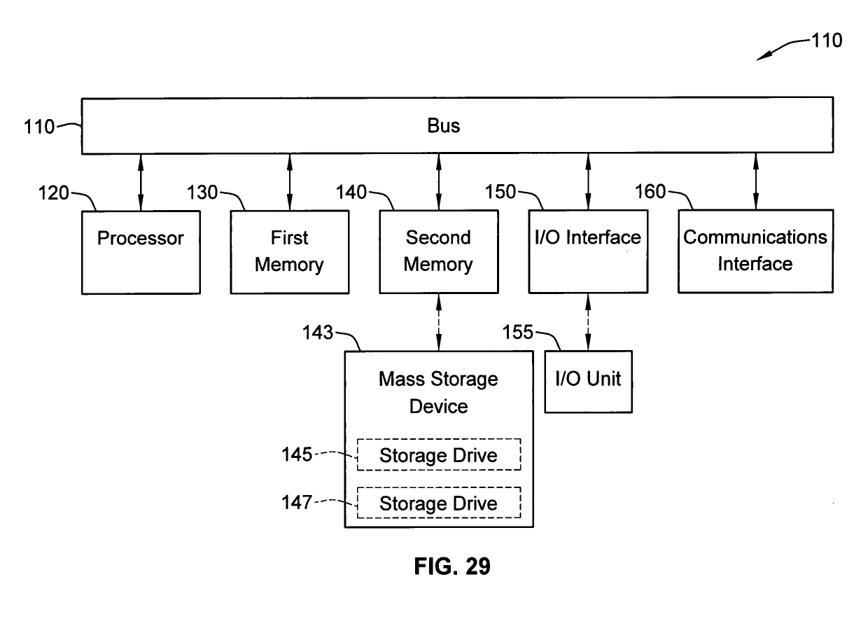

FIG. 29 illustrates an exemplary computer system 100, or network architecture, that may be used to implement the methods according to the present invention. One or more computer systems 100 may carry out the methods presented herein as computer code. One or more processors, such as processor 104, which may be a special purpose or a general-purpose digital signal processor, is connected to a communications infrastructure 106 such as a bus or network. Computer system 100 may further include a display interface 102, also connected to communications infrastructure 106, which forwards information such as graphics, text, and data, from the communication infrastructure 106 or from a frame buffer (not shown) to display unit 130. Computer system 100 also includes a main memory 105, for example random access memory (RAM), read-only memory (ROM), mass storage device, or any combination thereof. Computer system 100 may also include a secondary memory 110 such as a hard disk drive 112, a removable storage drive 114, an interface 120, or any combination thereof. Computer system 100 may also include a communications interface 124, for example, a modem, a network interface (such as an Ethernet card), a communications port, a PCMCIA slot and card, wired or wireless systems, etc.

It is contemplated that the main memory 105, secondary memory 110, communications interface 124, or a combination thereof function as a computer usable storage medium, otherwise referred to as a computer readable storage medium, to store and/or access computer software and/or instructions.

Removable storage drive 114 reads from and/or writes to a removable storage unit 115. Removable storage drive 114 and removable storage unit 115 may indicate, respectively, a floppy disk drive, magnetic tape drive, optical disk drive, and a floppy disk, magnetic tape, optical disk, to name a few.

In alternative embodiments, secondary memory 110 may include other similar means for allowing computer programs or other instructions to be loaded into the computer system 100, for example, an interface 120 and a removable storage unit 122. Removable storage units 122 and interfaces 120 allow software and instructions to be transferred from the removable storage unit 122 to the computer system 100 such as a program cartridge and cartridge interface (such as that found in video game devices), a removable memory chip (such as an EPROM, or PROM) and associated socket, etc.

Communications interface 124 allows software and instructions to be transferred between the computer system 100 and external devices. Software and instructions transferred by the communications interface 124 are typically in the form of signals 125 which may be electronic, electromagnetic, optical or other signals capable of being received by the communications interface 124. Signals 125 are provided to communications interface 124 via a communications path 126. Communications path 126 carries signals 125 and may be implemented using wire or cable, fiber optics, a phone line, a cellular phone link, a Radio Frequency (“RF”) link or other communications channels.

Computer programs, also known as computer control logic, are stored in main memory 105 and/or secondary memory 110. Computer programs may also be received via communications interface 124. Computer programs, when executed, enable the computer system 100, particularly the processor 104, to implement the methods according to the present invention. The methods according to the present invention may be implemented using software stored in a computer program product and loaded into the computer system 100 using removable storage drive 114, hard drive 112 or communications interface 124. The software and/or computer system 100 described herein may perform any one of, or any combination of, the steps of any of the methods presented herein. It is also contemplated that the methods according to the present invention may be performed automatically, or may be invoked by some form of manual intervention

The invention is also directed to computer products, otherwise referred to as computer program products, to provide software to the computer system 100. Computer products store software on any computer useable medium. Such software, when executed, implements the methods according to the present invention. Embodiments of the invention employ any computer useable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein can be implemented using software, hardware, firmware, or combinations thereof.

The computer system 100, or network architecture, of FIG. 29 is provided only for purposes of illustration, such that the present invention is not limited to this specific embodiment. It is appreciated that a person skilled in the relevant art knows how to program and implement the invention using any computer system or network architecture.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A computer system method for simulating natural human motion in computer animation, comprising the steps of:
inputting a skeletal model of the human body defined by mechanical properties of its segments;
applying to the skeletal model a forward recursive kinematics approach;
utilizing a backwards recursive dynamic formulation to produce sensitivities of kinematics equations and dynamics equations with respect to all the variables;
specifying a human performance objective function for a dynamic task;
identifying various constraints for the dynamic task to be simulated;
indicating the bound on joint angles and strength limits;
solving the optimization problem using an optimization algorithm to predict dynamic motion; and
generating a display of an animated human model.

2. The method of claim 1 wherein said using step further comprises the step of describing a large number of degrees of freedom for the kinematics of the human skeletal model with the Denavit-Hartenberg method wherein the joint angle profiles are the primary unknown variables.

3. The method of claim 2 wherein the joint angles profiles are joint angles as a function of time.

4. The method of claim 1 wherein said solving step further comprises the step of obtaining a solution with optimization and without resolving equations of motion.

5. The method of claim 1 wherein said using step further comprises the step of varying limits of at least one selected from the group of body size, shape, gender, strength, and fatigue.

6. The method of claim 1 wherein said using step further comprises the step of altering the load conditions on the human body.

7. The method of claim 6 wherein the load conditions of said altering step is at least one selected from the group of loads on the body, terrain topology and obstacles.

8. The method of claim 7 wherein the loads on the body are specified by load, position and orientation.

9. The method of claim 1 wherein said utilizing step further comprises the step of developing equations of motion for the human skeletal model based on the Lagrangian approach.

10. The method of claim 9 wherein said developing step further comprises the step of solving equations without numerical integration.

11. The method of claim 1 wherein the dynamic task of said specifying step is one selected from the group of discomfort, energy consumption, vision, dynamic effort, or any other function of kinematic and kinetic variables such as human performance measures to yield natural human motion for a given task.

12. The method of claim 11 wherein said utilizing step in combination with two or more human performance measures yields varying behavior for the predicted natural human motion.

13. The method of claim 1 wherein said utilizing step with varying cost functions and varying constraints enables the simulation of any human task while considering physics and naturalistic human behavior.

14. The method of claim 1 wherein said utilizing step further comprises the step of analyzing the human endurance limits given a trade-off analysis.
